(19) United States
(12) Patent Application Publication
(10) Pub. No.: US 2014/0316905 A1
(43) Pub. Date: Oct. 23, 2014

(54) SYSTEM AND METHOD FOR THREE-DIMENSIONAL ADVERTISING

(71) Applicants: Chan Ho Song, Seoul (KR); Gun Ho Song, Seoul (KR)

(72) Inventors: Chan Ho Song, Seoul (KR); Gun Ho Song, Seoul (KR)

(73) Assignee: AS ONE SYSTEM CO., LTD, Seoul (KR)

(21) Appl. No.: 14/358,543

(22) PCT Filed: Nov. 17, 2011
(86) PCT No.: PCT/KR2011/008818

§ 371 Date: May 15, 2014

(51) Int. Cl. G06Q 30/02

(52) U.S. Cl. CPC G06Q 30/0276
USPC 705/14.72

(57) ABSTRACT

The present invention relates to a system and method for three-dimensional advertising. The system and method of the present invention store advertisement data capable of being rendered as a three-dimensional object, the real position of which is designated. When a mobile communication terminal including a GPS receiver measures its own position, and transmits the position information of the mobile communication terminal to an advertisement server, an advertisement server transmits advertisement data set around the position information of the mobile communication terminal to the mobile communication terminal. The mobile communication terminal renders the advertisement data into a three-dimensional object, and displays the rendered advertisement data by overlapping same with a real image, which is displayed through a camera built in the mobile communication terminal. Therefore, the present invention can effectively expose advertisement information to a user by arousing the user's curiosity by making the advertisement object appear to exist in real space.

### TECHNICAL FIELD

The present invention relates to an advertisement system and method, and more particularly, to a system and method for three-dimensional (3D) advertising.

### BACKGROUND ART

As the conventional advertising method, signboards are installed on buildings, advertisement images are attached to show windows, or advertisement images are put in newspapers or magazines. However, in recent years when a super high-speed communication network has come into wide use due to development of information communication technique, banner advertisements are put on a web page so that a user who has accessed the Internet can be exposed to advertisements. A key word advertisement method is being actively performed. According to the key word advertisement method, when a user searches for a key word on an Internet portal site, search results on a product related to the key word are shown on the upper side.

However, the conventional advertising method cannot be implemented as an advertisement method appropriate for environments of smartphones which are rapidly becoming widely available in recent years. A user can search for his or her desired information by accessing the Internet anytime and anywhere using a smartphone, and can install various application programs in the smartphone to utilize them while moving or in his or her spare time. However, due to limitations of a portable device, the smartphone has a small display size. This may cause banner advertisements not to be viewable. Further, SMS advertisement messages, which have been performed in the conventional mobile terminal, are an out-of-date advertisement type not suitable for a smartphone. This may not attract a user's interest.

### DISCLOSURE OF THE INVENTION

Therefore, an object of the present invention is to provide a three-dimensional (3D) advertising system and method appropriate for environments of a high-tech mobile communication terminal such as a smartphone.

To achieve these and other advantages and in accordance with the purpose of the present invention, as embodied and broadly described herein, there is provided a system for three-dimensional advertising, including: an advertisement server configured to store therein advertisement data which is having advertisement position information corresponding to a real position and capable of being rendered as a three-dimensional object; and a mobile communication terminal configured to measure its position using a GPS and generate terminal position information corresponding to its position, configured to receive, from the advertisement server, advertisement data having advertisement position information set within a predetermined distance from the terminal position information, configured to render the advertisement data as a three-dimensional advertisement object based on the terminal position information, and configured to display the three-dimensional advertisement object on a display.

The mobile communication terminal may capture an image using a camera, and display three-dimensional advertisement object rendered from advertisement data, on a corresponding position in the captured image, in an overlapping manner.

The mobile communication terminal may measure its position and posture and generate terminal position information and posture information in three-dimensional space, and set the measured position information and posture information thereof as position information and posture information of a rendering camera, thereby performing rendering with respect to the advertisement data.

The posture information may be rotation information (roll, pitch and yaw) measured by a posture measuring module built in the mobile communication terminal.

The advertisement data may include the advertisement position information, modeling information including coordinate information of each vertex of a three-dimensional object, and mapping information.

The advertisement data may include the advertisement position information, modeling information, and mapping information, the modeling information including coordinate information on a reference vertex of a three-dimensional object and angle information on an angle formed between the three-dimensional object and a specific coordinate axis in three-dimensional space.

The mobile communication terminal may include: a camera module configured to capture a real image; a GPS module configured to measure a current position of the mobile communication terminal by receiving a GPS signal, thereby generating the terminal position information of the mobile communication terminal; a posture measuring module configured to generate posture information of the mobile communication terminal; a rendering camera setting unit configured to set a position and a posture of a rendering camera, based on the terminal position information and the posture information of the mobile communication terminal; an advertisement object modeling module configured to model a three-dimensional advertisement object, using advertisement data received from the advertisement server; and an image matching module configured to render the three-dimensional advertisement object using the rendering camera set by the rendering camera setting unit, and synthesize and display the rendered three-dimensional advertisement object on a corresponding region in an image captured by the camera module.

To achieve these and other advantages and in accordance with the purpose of the present invention, as embodied and broadly described herein, there is also provided a method for three-dimensional advertising in a mobile communication terminal where a three-dimensional advertisement application has been executed, the method comprising: (a) the mobile communication terminal's measuring its position using a GPS and generating terminal position information; (b) receiving, from an advertisement server, advertisement data having advertisement position information set within a predetermined distance from the position corresponding to the terminal position information of the mobile communication terminal; (c) rendering the advertisement data as a three-dimensional advertisement object based on the terminal position information of the mobile communication terminal; and (d) displaying the three-dimensional advertisement object on a display.

In the step of (d), the three-dimensional advertisement object, which has been rendered from the advertisement data, is displayed on a corresponding position in an image captured by a camera built in the mobile communication terminal, in an overlapping manner.

In the step of (d), rendering of the three-dimensional advertisement object is performed by measuring posture of the mobile communication terminal and generating posture information thereof, and by setting the terminal position information and posture information of the mobile communication terminal as position information and posture information of a rendering camera.

The posture information may be rotation information (roll, pitch and yaw) measured by a posture measuring module built in the mobile communication terminal.

The advertisement data may include the advertisement position information, modeling information including coordinate information on each vertex of a three-dimensional object, and mapping information.

The advertisement data may include the advertisement position information, modeling information, and mapping information, the modeling information including coordinate information on a reference vertex of a three-dimensional object and angle information on an angle formed between the three-dimensional object and a specific coordinate axis in three-dimensional space.

The step of (d) may include: (d1) measuring posture of the mobile communication terminal and generating posture information thereof; (d2) setting a position and a posture of a rendering camera, using the terminal position information and the posture information of the mobile communication terminal; (d3) modeling a three-dimensional advertisement object, using advertisement data received from the advertisement server; and (d4) rendering the three-dimensional advertisement object, using the rendering camera set in the step of (d2).

In the present invention, advertisement data capable of being rendered as a three-dimensional object is stored, in a state that a real position of the advertisement data is designated. When a mobile communication terminal including a GPS receiver measures its own position, and transmits the position information thereof to an advertisement server, the advertisement server transmits advertisement data set around the position of the mobile communication terminal to the mobile communication terminal. The mobile communication terminal renders the advertisement data into a three-dimensional object, and displays the rendered advertisement data by overlapping the same with a real image, which is displayed through a camera built in the mobile communication terminal. Therefore, the present invention can effectively expose advertisement information to a user by arousing the user's curiosity by making the advertisement object appear to exist in real space.

### BRIEF DESCRIPTION OF THE DRAWINGS

FIG. 1 is a view illustrating an entire configuration of a three-dimensional advertising system according to a preferred embodiment of the present invention;

FIG. 2 is a block diagram illustrating a structure of a mobile communication terminal according to a preferred embodiment of the present invention;

FIG. 3 is a flowchart explaining a three-dimensional advertising method according to a preferred embodiment of the present invention;

FIG. 4 is a detailed flow chart of step S360 shown in FIG. 3;

FIG. 5 is a view illustrating an example to set a rendering camera; and

FIGS. 6 and 7 are views illustrating an example of a three-dimensional advertisement image displayed on a mobile communication terminal according to the present invention.

### MODES FOR CARRYING OUT THE PREFERRED EMBODIMENTS

Hereinafter, preferred embodiments of the present invention will be explained with reference to the attached drawings.

Three-dimensional (3D) advertisement service of the present invention may be executed as independent service, or may be applied together with other application programs using augmented reality (e.g., an application program for searching for facility such as nearby restaurants, pharmacies and theaters, etc. using augmented reality). Hereinafter, only procedures to perform a method for 3D advertising according to the present invention will be explained for convenience.

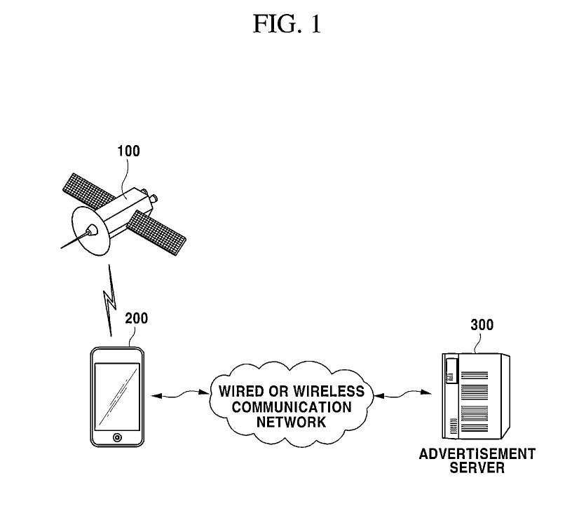

FIG. 1 is a view illustrating an entire configuration of a three-dimensional advertising system according to a preferred embodiment of the present invention.

Referring to FIG. 1, the advertising system according to a preferred embodiment of the present invention includes a mobile communication terminal 200 where a three-dimensional advertisement application program is executed; and an advertisement server 300 configured to store therein advertisement data to be displayed as a three-dimensional object.

The advertisement server 300 stores advertisement data to be displayed to a user by being rendered as a three-dimensional object. When the mobile communication terminal 200 requests advertisement data, the advertisement server 300 checks a current position of the mobile communication terminal 200 based on terminal position information of the mobile communication terminal received from the mobile communication terminal 200. Then the advertisement server 300 transmits, to the mobile communication terminal 200, advertisement data having an advertisement position information set within a predetermined distance from the current position of the mobile communication terminal 200.

The advertisement data transmitted to the mobile communication terminal 200 by the advertisement server 300 includes advertisement position information, information on modeling of a three-dimensional (3D) object, and mapping information.

The modeling information means information used to perform 3D modeling in 3D rendering software such as 3D MAX or MAYA (e.g., absolute or relative coordinate value of each vertex, etc.), and the mapping information means information on a color or texture of a modeled 3D object. The modeling information may include coordinate information of a reference vertex and angular information on an angle formed between a 3D object and a specific coordinate axis in 3D space instead of coordinate information of each vertex.

The advertisement position information is information indicating a position corresponding to a real position on the earth, which has a latitude and a longitude of a center point of a rendered 3D advertisement object. Upon reception of position information of the mobile communication terminal 200, the advertisement server 300 searches for advertisement data having advertisement position information set within a predetermined distance from the current position of the mobile communication terminal 200, and transmits the advertisement data to the mobile communication terminal 200. If coordinate information on each vertex included in modeling information has coordinate information corresponding to a real position on the earth, the advertisement position information may be set as coordination information of a reference vertex included in modeling information.

The mobile communication terminal 200 downloads a 3D advertisement application by accessing the advertisement server 300, an application store, etc., and executes the 3D advertisement application, thereby providing 3D advertisement service of the present invention to a user.

The mobile communication terminal 200 generates its position information (terminal position information) by measuring its real position using a GPS, and receives, from the advertisement server 300, advertisement data having advertisement position information set within a predetermined distance from the current position of the mobile communication terminal 200. The mobile communication terminal 200 renders the received advertisement data as a 3D advertisement object, based on the terminal position information of the mobile communication terminal 200, thereby displaying an image captured by a camera and the rendered 3D advertisement object on a display in an overlapping manner.

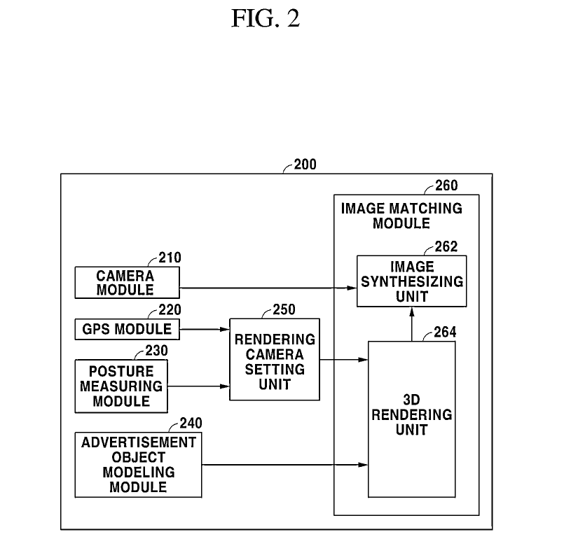

FIG. 2 is a block diagram illustrating a structure of the mobile communication terminal 200 according to a preferred embodiment of the present invention.

Referring to FIG. 2, the mobile communication terminal 200, in which a 3D advertisement application has been installed, includes a camera module 210, a GPS module 220, a posture measuring module 230, a rendering camera setting unit 250, an advertisement object modeling module 240, and an image matching module 260. The image matching module 260 includes a 3D rendering unit 264 and an image synthesizing unit 262.

Upon execution of a 3D advertisement application of the present invention, the camera module 210 captures a real image using a camera installed at the mobile communication terminal 200, and outputs the captured real image to the image synthesizing unit 262.

Upon execution of a 3D advertisement application of the present invention, the GPS module 220 receives a GPS signal from a GPS satellite 100 to measure a real position of the mobile communication terminal 200. Then the GPS module 220 generates terminal position information of the mobile communication terminal 200, and outputs the generated terminal position information to the rendering camera setting unit 250.

Upon execution of a 3D advertisement application of the present invention, the posture measuring module 230 generates posture information of the mobile communication terminal 200, and outputs the generated posture information to the rendering camera setting unit 250. The posture information is information on a tilted degree and a direction of the mobile communication terminal 200, which indicates a tilted degree in a direction. The posture measuring module 230 may be implemented as a 3-axis acceleration sensor. However, in the present invention, the posture measuring module 230 is implemented as a gyro sensor to measure a posture of the mobile communication terminal 200. The posture information is implemented as rotation information of the mobile communication terminal 200 expressed as roll, pitch and yaw.

The rendering camera setting unit 250 sets a position and a posture of a rendering camera, based on terminal position information and posture information of the mobile communication terminal 200. The rendering camera is well-known in the field of 3D graphics, and thus its detailed explanations will be omitted. The rendering camera setting unit 250 sets a latitude and a longitude of terminal position information of the mobile communication terminal 200, as an origin of two coordinate axes among three coordinate axes in 3D space. Then the rendering camera setting unit 250 sets a height of the mobile communication terminal 200, as a height of a rendering camera of the rest one coordinate axis.

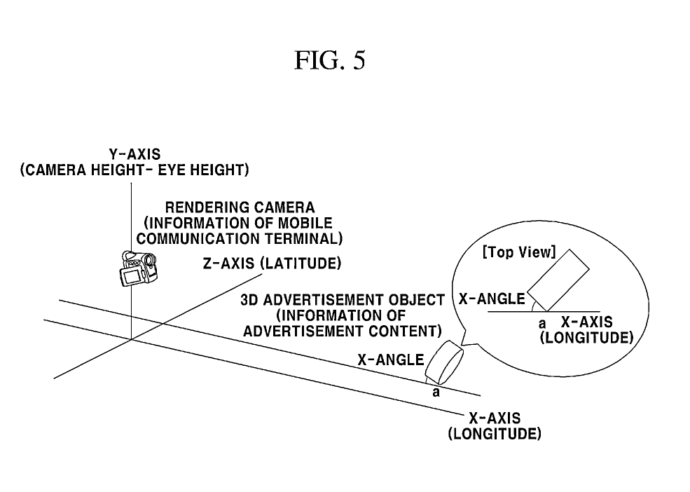

FIG. 5 is a view illustrating an example to set a rendering camera. Referring to FIG. 5, a longitude of the mobile communication terminal 200 has been set as an origin of an x-axis, a latitude of the mobile communication terminal 200 has been set as an origin of a z-axis, and a height of the mobile communication terminal 200 has been set as a height of a rendering camera in a y-axis direction.

The advertisement object modeling module 240 performs modeling with respect to an advertisement object, using modeling information among advertisement data received from the advertisement server 300. In a case where the modeling information of the advertisement data includes a coordinate value of each vertex of a three-dimensional (3D) object, modeling may be performed by setting vertex at the positions corresponding to coordinate values of each vertex. In a case where the modeling information includes a coordinate value of a reference vertex (a) and information on an angle formed between 3D object and a coordinate axis in 3D space, as shown in FIG. 5, the reference vertex (a) of a 3D object may be set to perform modeling with respect to the 3D object. Such modeling may be performed by rotating a generated 3D object by a prescribed angle (x-angle) with respect to a coordinate axis based on a reference vertex. The method for modeling a 3D object is the same as a method for modeling a 3D object in 3D graphic programs such as well-known 3D Max and Maya, and detailed explanations thereof will be omitted.

The 3D rendering unit 264 captures a 3D advertisement object modeled by the advertisement object modeling module 240, using a rendering camera set by the rendering camera setting unit 250. Then the 3D rendering unit 264 performs 3D rendering such as implementation of a color and texture, with respect to the 3D advertisement object, based on mapping information. Then the 3D rendering unit 264 outputs a rendering image to the image synthesizing unit 262. If a 3D advertisement is performed at a daytime, a position of a rendering optical source is set by measuring a real position of the sun by calculating position information of the mobile communication terminal, a date and time. On the other hand, if a 3D advertisement is performed at a nighttime, rendering is performed by setting a predefined position as a position of a rendering optical source.

The image synthesizing unit 262 displays a 3D advertisement object image input from the 3D rendering unit 264, on a corresponding region in an image captured by the camera module 210, in an overlapping manner.

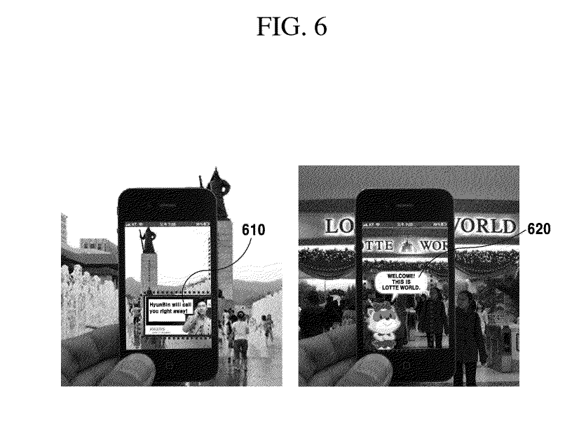

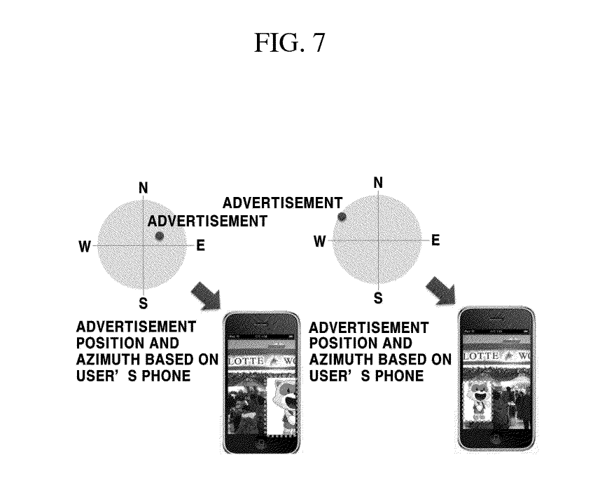

FIGS. 6 and 7 are views illustrating an example of a 3D advertisement image displayed on the mobile communication terminal 200 according to the present invention.

Referring to FIG. 6, upon execution of a 3D advertisement application of the present invention, a foreground image is displayed on a display of the mobile communication terminal 200, and advertisement images 610, 620 having advertisement positions preset within a image capturing range are displayed. A position and a shape of advertisement data modeled into a 3D object are fixed. Accordingly, if a user moves forward with holding the mobile communication terminal 200, not only a real background image, but also a modeled advertisement object is displayed in a gradually-enlarged manner. If the user passes the position of the modeled advertisement data, the advertisement data is not displayed any longer. If the user who has passed the set position of the advertisement data captures the image after turning his or her body backward, a rear image of the advertisement object is displayed on the display of the mobile communication terminal 200.

If a user changes a capturing direction using a camera of the mobile communication terminal 200, a position of the advertisement object on the display is also changed, because the position of the advertisement data is fixed. Referring to FIG. 7, if a user moves backward with rotating the mobile communication terminal 200 to the right side, a relative position of the advertisement data with respect to the mobile communication terminal 200 is changed to a remote distance of the northwest from a near distance of the northeast. As a result, the advertisement object, which has been displayed on the right lower side of the display as a large image, is displayed on the left lower side of the display as a small image.

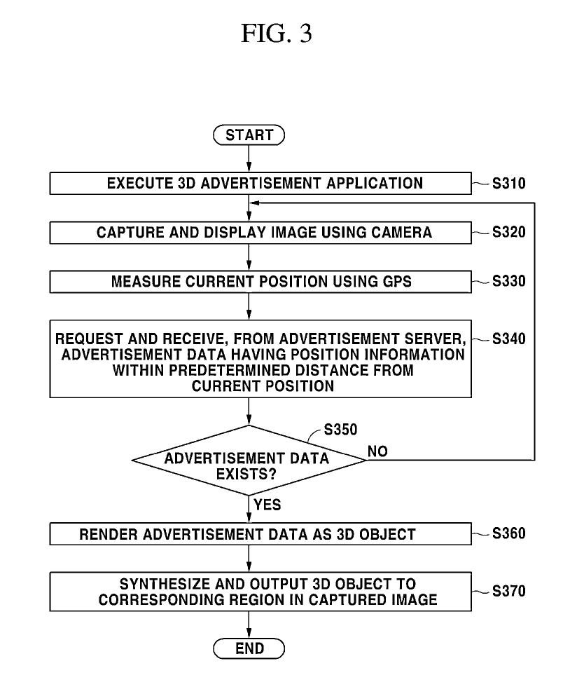

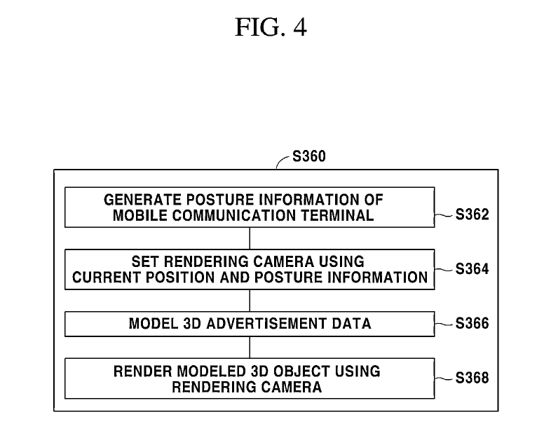

FIG. 3 is a flowchart explaining a three-dimensional advertising method according to a preferred embodiment of the present invention, and FIG. 4 is a detailed flow chart of step S360 shown in FIG. 3.

Functions performed in respective steps of FIGS. 3 and 4 have been aforementioned with reference to FIGS. 1 and 2, and thus detailed explanations thereof will be omitted. Procedures to perform a method for 3D advertising according to a preferred embodiment of the present invention will be explained with reference to FIGS. 3 and 4.

Referring to FIG. 3, once a user executes a 3D advertisement application of the present invention using the mobile communication terminal 200 (S310), the mobile communication terminal 200 captures a front image using a camera built therein, and displays the captured image on a display thereof (S320).

Then the mobile communication terminal 200 generates terminal position information thereof by measuring its real position using a GPS module 220 (S330). Then the mobile communication terminal 200 transmits the terminal position information to an advertisement server 300 through a wired or wireless communication network. The advertisement server 300, which has received the terminal position information of the mobile communication terminal 200 from the mobile communication terminal 200, transmits, to the mobile communication terminal 200, advertisement data having advertisement position information set within a predetermined distance from the current position of the mobile communication terminal 200, among a plurality of pre-stored advertisement data. The mobile communication terminal 200 receives the advertisement data (S340).

The mobile communication terminal 200 checks whether there exists the advertisement data received from the advertisement server 300. If there does not exist the advertisement data, i.e., if there is no advertisement data set around the mobile communication terminal 200, the mobile communication terminal 200 performs S320. The mobile communication terminal 200 continuously captures an image using the camera, and transmits its terminal position information which is changed while a user moves, to the advertisement server 300, to thus request for advertisement data (S350). Such processes are repeatedly performed.

Upon reception of the advertisement data, the mobile communication terminal 200 renders the advertisement data as a 3D advertisement object (S360). Then the mobile communication terminal 200 synthesizes and outputs, the rendered 3D advertisement object, to a corresponding region in an image captured by the camera (S370).

S360 will be explained in more detail with reference to FIG. 7. If there exists received advertisement data, the mobile communication terminal 200 generates its posture information on a tilted degree and a direction, using a posture measuring module 230 provided therein (S362). Then the mobile communication terminal 200 sets a position and a posture of a rendering camera, based on its terminal position information and posture information (S364).

Then the mobile communication terminal 200 performs modeling with respect to the 3D advertisement object, based on modeling information of the advertisement data received from the advertisement server 300 (S366). Then the mobile communication terminal 200 renders the modeled 3D advertisement object, using the rendering camera set in S364 (S368).

The present invention may be implemented using a recording medium which can be read by a computer and a mobile communication terminal such as a smartphone, in the form of a code which can be read by a computer and a mobile communication terminal such as a smartphone. Examples of possible recording mediums include ROM, RAM, CD-ROM, a magnetic tape, a floppy disk, an optical data storage device, etc. If desired, the recording medium may be realized in the form of a carrier wave (for example, a transmission over the Internet). The recording medium, which can be read by a computer and a mobile communication terminal such as a smartphone, may be distributed to a computer system connected thereto through network. Codes, which can be read by a computer and a mobile communication terminal such as a smartphone, may be stored and executed in a distributing manner.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1. A system for three-dimensional advertising, comprising:
an advertisement server configured to store therein advertisement data which is having advertisement position information corresponding to a real position and capable of being rendered as a three-dimensional object; and
a mobile communication terminal configured to measure its position using a GPS and generate terminal position information corresponding to its position, configured to receive, from the advertisement server, advertisement data having advertisement position information set within a predetermined distance from the terminal position information, configured to render the advertisement data as a three-dimensional advertisement object based on the terminal position information, and configured to display the three-dimensional advertisement object on a display.

2. The system of claim 1, wherein the mobile communication terminal captures an image using a camera, and displays three-dimensional advertisement object rendered from advertisement data, on a corresponding position in the captured image, in an overlapping manner.

3. The system of claim 2, wherein the mobile communication terminal measures its position and posture and generates terminal position information and posture information in three-dimensional space, and sets the measured position information and posture information thereof as position information and posture information of a rendering camera, thereby performing rendering with respect to the advertisement data.

4. The system of claim 3, wherein the posture information is rotation information (roll, pitch and yaw) measured by a posture measuring module built in the mobile communication terminal.

5. The system of claim 1, wherein the advertisement data includes the advertisement position information, modeling information including coordinate information of each vertex of a three-dimensional object, and mapping information.

6. The system of claim 1, wherein the advertisement data includes the advertisement position information, modeling information, and mapping information, the modeling information including coordinate information on a reference vertex of a three-dimensional object and angle information on an angle formed between the three-dimensional object and a specific coordinate axis in three-dimensional space.

7. The system of claim 1, wherein the mobile communication terminal comprises:
a camera module configured to capture a real image;
a GPS module configured to measure a current position of the mobile communication terminal by receiving a GPS signal, thereby generating the terminal position information of the mobile communication terminal;
a posture measuring module configured to generate posture information of the mobile communication terminal;
a rendering camera setting unit configured to set a position and a posture of a rendering camera, based on the terminal position information and the posture information of the mobile communication terminal;
an advertisement object modeling module configured to model a three-dimensional advertisement object, using advertisement data received from the advertisement server; and
an image matching module configured to render the three-dimensional advertisement object using the rendering camera set by the rendering camera setting unit, and synthesize and display the rendered three-dimensional advertisement object on a corresponding region in an image captured by the camera module.

8. A method for three-dimensional advertising in a mobile communication terminal where a three-dimensional advertisement application has been executed, the method comprising:
(a) the mobile communication terminal's measuring its position using a GPS and generating terminal position information;
(b) receiving, from an advertisement server, advertisement data having advertisement position information set within a predetermined distance from the position corresponding to the terminal position information of the mobile communication terminal;
(c) rendering the advertisement data as a three-dimensional advertisement object based on the terminal position information of the mobile communication terminal; and
(d) displaying the three-dimensional advertisement object on a display.

9. The method of claim 8, wherein in the step of (d), the three-dimensional advertisement object, which has been rendered from the advertisement data, is displayed on a corresponding position in an image captured by a camera built in the mobile communication terminal, in an overlapping manner.

10. The method of claim 9, wherein in the step of (d), rendering of the three-dimensional advertisement object is performed by measuring posture of the mobile communication terminal and generating posture information thereof, and by setting the terminal position information and posture information of the mobile communication terminal as position information and posture information of a rendering camera.

11. The method of claim 10, wherein the posture information is rotation information (roll, pitch and yaw) measured by a posture measuring module built in the mobile communication terminal.

12. The method of claim 8, wherein the advertisement data includes the advertisement position information, modeling information including coordinate information on each vertex of a three-dimensional object, and mapping information.

13. The method of claim 8, wherein the advertisement data includes the advertisement position information, modeling information, and mapping information, the modeling information including coordinate information on a reference vertex of a three-dimensional object and angle information on an angle formed between the three-dimensional object and a specific coordinate axis in three-dimensional space.

14. The method of claim 8, wherein the step of (d) includes:
(d1) measuring posture of the mobile communication terminal and generating posture information thereof;
(d2) setting a position and a posture of a rendering camera, using the terminal position information and the posture information of the mobile communication terminal;
(d3) modeling a three-dimensional advertisement object, using advertisement data received from the advertisement server; and
(d4) rendering the three-dimensional advertisement object, using the rendering camera set in the step of (d2).

15. A recording medium which is capable of reading the method of claim 8, in a computer and a mobile communication terminal, and the recording medium on which an executable program code has been recorded.
